(19) United States
(12) Patent Application Publication
(10) Pub. No.: US 2012/0050317 A1
(43) Pub. Date: Mar. 1, 2012

(54) ELECTRONIC DEVICE AND METHOD OF VIEWING DISPLAY OF AN ELECTRONIC MAP

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/071,421

(22) Filed: Mar. 24, 2011

(30) Foreign Application Priority Data
Aug. 26, 2010 (TW) 99128718

(51) Int. Cl. G09G 5/00

(52) U.S. Cl. 345/619

(57) ABSTRACT

A method for viewing display of an electronic map displays a portion of the electronic map on a display of the electronic device, and detects an orientation of the electronic device using an electronic compass. The method further adjusts an orientation of the electronic map to the orientation of the electronic device, and measures a tilt angle and a tilt angle of the electronic device using an electronic compass, to determine movements of the electronic device and adjustments to the portion of the electronic map. Display of the electronic map is changed according to the movements and the adjustments.

### BACKGROUND

1. Technical Field

Embodiments of the present disclosure generally relate to electronic devices, and more particularly to an electronic device and a method of viewing display of an electronic map stored in the electronic device.

2. Description of Related Art

Electronic maps are commonly used in electronic devices, such as mobile phones and personal digital assistants (PDA). A user of an electronic device may search for desired information, such as stores, hotels, using the electronic map. However, displays of electronic devices are usually small, and the user may only view a part of the electronic map at one time. If the user intends to view other parts of the electronic map, the user may move the electronic map by operating navigation keys or a touch panel of the electronic device. However, the user may have to repeatedly operate the navigation keys or the touch panel for viewing desired information provided on the electronic map.

### BRIEF DESCRIPTION OF THE DRAWINGS

FIG. 1 is a block diagram of one embodiment of function modules of an electronic device.

FIG. 2 is a flowchart illustrating one embodiment of a method of viewing display of an electronic map on a display of an electronic device.

FIG. 3 is an example illustrating an electronic map in one embodiment.

FIG. 4 is an example illustrating adjusting an orientation of an electronic map in one embodiment.

### DETAILED DESCRIPTION

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

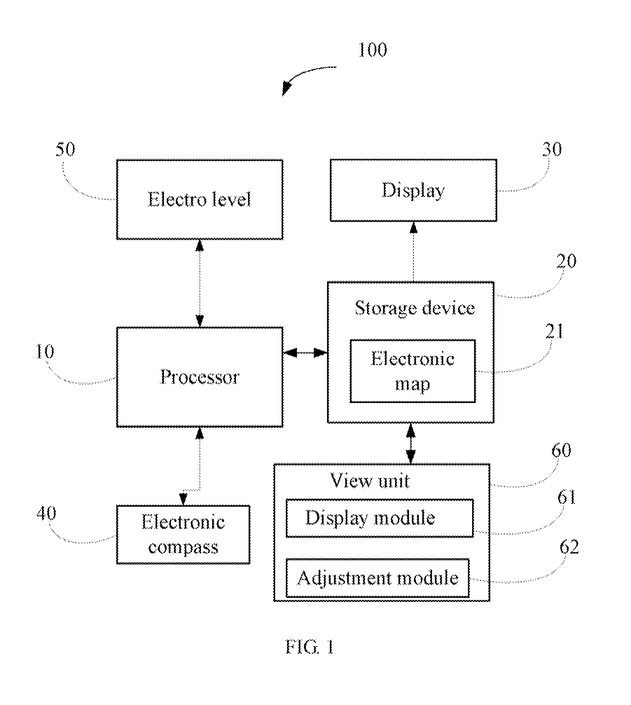

FIG. 1 is a block diagram of one embodiment of an electronic device 100. In the embodiment, the electronic device 100 is a portable device such as a mobile phone, a personal digital assistant (PDA), for example, and can indicate position of the electronic device 100 on an electronic map 21. The electronic device 100 includes a processor 10, a storage device 20, a display 30, an electronic compass 40, an electro level 50, and a view unit 60. The storage device 20 stores the electronic map 21. The electronic device 100 allows a user to adjust view of the electronic map 21 displayed on the display 30 by performing gestures with the device 100 as will be explained in detail below.

The electronic compass 40 is configured to detect an orientation of the electronic device 100. For example, in the embodiment, the orientation is the direction a user is assumed to be facing when viewing the display 30 of the electronic device 100. The electronic compass 40, unlike a common compass, has a magneto resistive transducer that is distinct from a magnetic needle of a common compass. Because of Lorentz force of the magneto resistive transducer, the electronic compass 40 can calculate a voltage variation of a point charge, and determine the orientation of the electronic device 100 according to the voltage variation.

The orientation of the electronic device 100 (and thus, display of the electronic device 100) can be oriented in a landscape view or a portrait view, where the portrait view is an ninety degree orientation from the landscape view. It should be understood that, the electronic device 100 may have a display that has a 1×1, 3×2, 16×9, 16×10, or other views/resolution, which can be considered as either a portrait view or landscape view depending on orientation of the electronic device 100, regardless of whether the electronic device 100 is being held up, or lying flat on a surface, such as a table, in one example.

The electro level 50 detects if the electronic device 100 is deviated from a default orientation (e.g., the portrait or landscape orientation/view). In one example, if the back surface of the electronic device 100 is not substantially parallel to the default orientation, the electro level 50 detects a tilt direction and a tilt angle of the electronic device 100 with respect to the default orientation. In this embodiment, the electro level 50 is a gravity sensor, which detects the tilt direction and the tilt angle of the electronic device 100 with respect to the direction of the force of gravity.

The view unit 60 includes a display module 61 and an adjustment module 62. One or more computerized codes of the display module 61 and the adjustment module 62 are stored in the storage device 20. The processor 10 executes the one or more computerized codes, to provide functions of the display module 61 and the adjustment module 62.

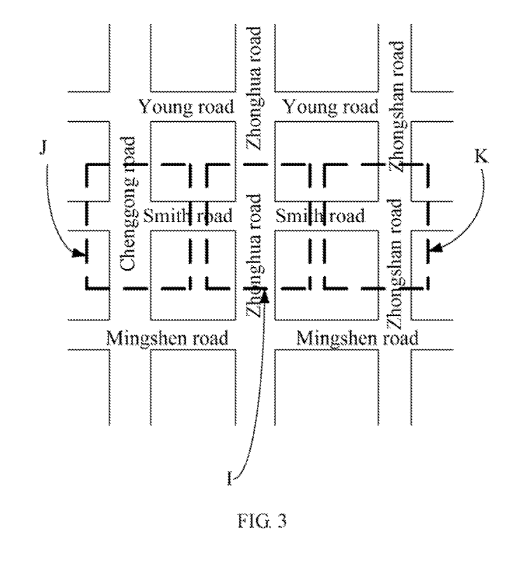

The display module 61 is operable to open the electronic map 21 stored in the storage device 20, and display a view of the electronic map 21 on the display 30 in response to a selection signal. It should be understood that a map image may not be easy to view clearly if sized to fit the display 30, such as the electronic map 21 (as shown in FIG. 3) cannot be completely displayed on the display 30 in its current size. Therefore, the display module 61 only displays a portion of the electronic map 21, such as any one of dashed blocks labeled as J, K, and I on the display 30.

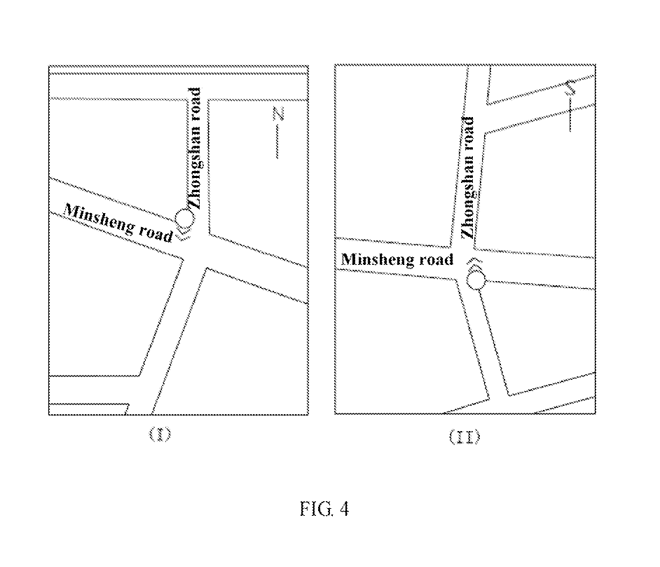

The adjustment module 62 is operable to adjust an orientation of the electronic map 21 according to the orientation of the electronic device 100. That is, the map is oriented such that the direction the user is presumed to be facing accords with the top of the map, and any markings or legends are accordingly oriented to be easily read. For example, if the orientation of the electronic device 100 has just changed to be oriented in the portrait view and the orientation of the electronic map 21 is in the landscape view, then, the adjustment module 62 adjusts orientation of the electronic map 21 to be in the portrait view. For example, in FIG. 4(I) and FIG. 4(II), the double-headed arrow represents the orientation of the electronic device 100 is portrait. In FIG. 4(I), the orientation of the electronic map 21 is landscape, and in FIG. 4(II), the orientation of the electronic map 21 has adjusted to the same as the orientation of the electronic device 100.

The adjustment module 62 is also operable to recognize movements of the electronic device 100 according to the tilt direction and the tilt angle, and determine adjustments to the portion of the electronic map 21 according to preset associations between the movements of the electronic device and the adjustments to the view of the electronic map 21, to display a different portion of the electronic map 21 on the display 30. In this embodiment, the preset associations between the movements of the electronic device 100 and the adjustments to the portion of the electronic map 21 are set for the adjustment module 62 and stored in the storage device 20. For example, a display region of the display 30 may be divided into 20×30 grids. If the user tilts the electronic device 100 by a first predetermined degree (such as ten degrees) right or left according to a longitudinal axis of the electronic device 100 from an initial position and back again to the initial position, the view of the electronic map 21 may pan first predetermined grids (such as 4 grids) left or right accordingly, to show a different portion of the electronic map 21. If the user tilts the electronic device 100 by a second predetermined angle about its latitudinal axis from the initial position and back again to the initial position, then the portion of the electronic map 21 may pan up or down by second predetermined grids accordingly. As shown FIG. 3, the dashed box I shows an initial view on the display 30, and if the user tilts the electronic device 100 left the view is accordingly switched to show the dashed box J, or if the user tilts the device 100 right the view is switched to show the dashed box K.

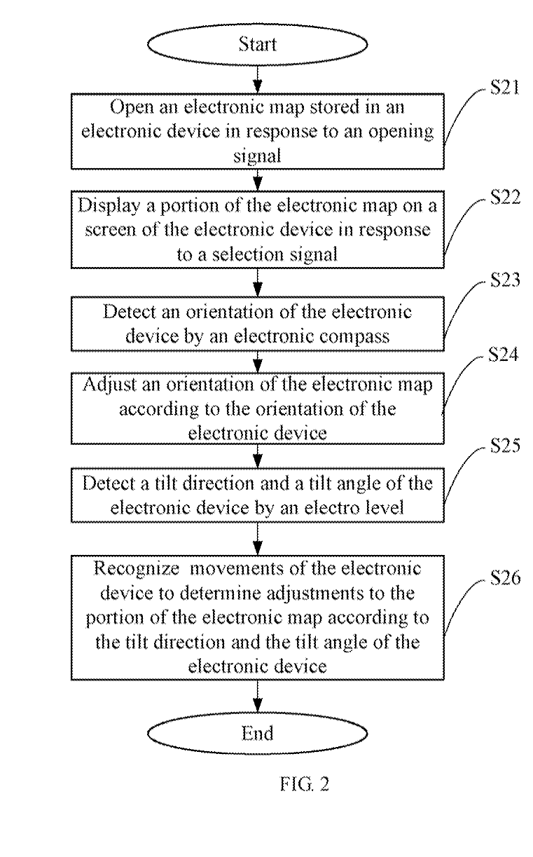

FIG. 2 is a flowchart illustrating one embodiment of a method of viewing display of an electronic map 21 on the display 30 of the electronic device 100. Depending on the embodiment, additional blocks may be added, others removed, and the ordering of the blocks may be changed.

In block S21, the display module 61 opens the electronic map 21 stored in the storage device 20 in response to an opening signal. A user of the electronic device 100 may trigger the opening signal by touching the display 30 or operating a keyboard of the electronic device 100.

In block S22, the display module 61 displays a portion of the electronic map 21, such as the view shown in the dashed block I in FIG. 3, on the display 30 in response to a selection signal. The selection signal may be triggered by touching the display 30 or operating the keyboard of the electronic device 100.

In block S23, the electronic compass 40 detects an orientation of the electronic device 100. As mentioned above, the orientation is the direction a user is assumed to be facing when viewing the display 30 of the electronic device 100.

In block S24, the adjustment module 62 adjusts an orientation of the electronic map 21 according to the orientation of the electronic device 100. That is, the map is oriented such that the direction the user is presumed to be facing accords with the top of the map, and any markings or legends are accordingly oriented to be easily read. For example, if the orientation of the electronic device 100 has just changed to be oriented in a portrait view and the orientation of the electronic map 21 is in a landscape view, then, the adjustment module 62 adjusts orientation of the electronic map 21 to be in the portrait view.

For example, in FIG. 4(I) and FIG. 4(II), the double-headed arrow represents the orientation of the electronic device 100 is portrait. In FIG. 4(I), the orientation of the electronic map 21 is landscape, and in FIG. 4(II), the orientation of the electronic map 21 has adjusted to the same as the orientation of the electronic device 100.

In block S25, the electro level 50 detects a tilt direction and a tilt angle of the electronic device 100 with respect to a default orientation (e.g., the portrait or landscape orientation/view). For example, if the back surface of the electronic device 100 is substantially not parallel to the default orientation, the electro level 50 detects a tilt direction and a tilt angle of the electronic device 100 with respect to the default orientation.

In block S26, the adjustment module 62 recognizes movements of the electronic device 100 according to the tilt direction and the tilt angle, and determines adjustments to the portion of the electronic map 21 according to preset associations between the movements of the electronic device and the adjustments to the portion of the electronic map 21, to display a different portion of the electronic map 21 on the display 30. As mentioned above, the preset associations between the movements of the device 100 and the adjustments to the portion of the electronic map 21 are set for the adjustment module 62 and stored in the storage device 20. As mentioned above, a display region of the display 30 may be divided into 20×30 grids. If the user tilts the electronic device 100 by a first predetermined degree (such as ten degrees) according to a longitudinal axis of the electronic device 100 from an initial position and back again to the initial position, the portion of the electronic map 21 may pan first predetermined grids (such as four grids) left or right accordingly, to show a different portion of the electronic map 21. If the user tilts the electronic device 100 by a second predetermined degree about its latitudinal axis from the initial position and back again to the initial position, then the portion of the map 21 may pan up or down by second predetermined grids accordingly. As shown FIG. 3, the dashed box I shows an initial view on the display 30, and if the user tilts the electronic device 100 left the view is accordingly switched to show the dashed box J, or if the user tilts the device 100 right the view is switched to show the dashed box K.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method of viewing display of an electronic map on a display of an electronic device comprising an electro level, and an electronic compass, the method comprising:
displaying a portion of the electronic map on the display of the electronic device in response to a selection signal;
detecting an orientation of the electronic device using the electronic compass;
adjusting an orientation of the electronic map according to the orientation of the electronic device;
detecting a tilt direction and a tilt angle of the electronic device with respect to a default orientation using the electro level; and
recognizing movements of the electronic device according to the tilt direction and the tilt angle, and determining adjustments to the portion of the electronic map according to preset associations between the movements of the electronic device and the adjustments to the portion of the electronic map, to display a different portion of the electronic map on the display.

2. The method as claimed in claim 1, wherein the orientation of the electronic device is the direction a user is assumed to be facing when viewing the display of the electronic device.

3. The method as claimed in claim 1, wherein the default orientation is a portrait orientation or a landscape orientation.

4. The method as claimed in claim 1, wherein the preset associations comprise that if the electronic device rotates a first predetermined degree left or right according to a longitudinal axis of the electronic device from an initial position and back again to the initial position, the portion of the electronic map pans a first predetermined distance left or right.

5. The method as claimed in claim 1, wherein the preset associations comprise that if the electronic device rotates a second predetermined degree up or down according to an latitudinal axis of the electronic device from an initial position and back again to the initial position, the portion of the electronic map pans a second predetermined distance up or down.

6. An electronic device, comprising:
a display;
a storage device;
one or more processors;
an electronic compass operable to detect an orientation of the electronic device;
an electro level operable to detect a tilt direction and a tilt angle of the electronic device with respect to a default orientation; and
one or more programs stored in the storage device and configured for execution by the one or more processors, the one or more programs comprising:
a display module operable to open an electronic map stored in the storage device in response to an opening signal, and to display a portion of the electronic map on the display in response to a selection signal; and
an adjustment module operable to adjust an orientation of the electronic map according to the orientation of the electronic device, recognize movements of the electronic device according to the tilt direction and the tilt angle, and determine adjustments to the portion of the electronic map according to preset associations between the movements of the electronic device and the adjustments to the portion of the electronic map, to display a different portion of the electronic map on the display.

7. The device as claimed in claim 6, wherein the orientation of the electronic device is the direction a user is assumed to be facing when viewing the display of the electronic device.

8. The device as claimed in claim 6, wherein the default orientation is a portrait orientation or a landscape orientation.

9. The device as claimed in claim 6, wherein the preset associations comprise that if the electronic device rotates a first predetermined degree left or right according to a longitudinal axis of the electronic device from an initial position and back again to the initial position, the portion of the electronic map pans a first predetermined distance left or right.

10. The device as claimed in claim 6, wherein the preset associations comprise that if the electronic device rotates a second predetermined degree up or down according to an latitudinal axis of the electronic device from an initial position and back again to the initial position, the portion of the electronic map pans a second predetermined distance up or down.

11. The device as claimed in claim 6, wherein the opening signal and the selection signal are triggered by touching the display or operating a keyboard of the electronic device.

12. A non-transitory storage medium having stored thereon instructions that, when executed by at least one processor of an electronic device, to perform a method of viewing an electronic map stored in an electronic device, the method comprising:
displaying a region of the electronic map on a display of the electronic device in response to a selection signal;
detecting an orientation of the electronic device using an electronic compass of the electronic device;
adjusting an orientation of the electronic map according to the orientation of the electronic device;
detecting a tilt direction and a tilt angle of the electronic device with respect to a default orientation using an electro level of the electronic device; and
recognizing movements of the electronic device according to the tilt direction and the tilt angle, and determining adjustments to the portion of the electronic map according to preset associations between the movements of the electronic device and the adjustments to the portion of the electronic map, to display a different portion of the electronic map on the display.

13. The non-transitory storage medium as claimed in claim 12, wherein the orientation of the electronic device is the direction a user is assumed to be facing when viewing the display of the electronic device.

14. The non-transitory storage medium as claimed in claim 12, wherein the default orientation is a portrait orientation or a landscape orientation.

15. The non-transitory storage medium as claimed in claim 12, wherein the preset associations comprise that if the electronic device rotates a first predetermined degree left or right according to a longitudinal axis of the electronic device from an initial position and back again to the initial position, the portion of the electronic map pans a first predetermined distance left or right.

16. The non-transitory storage medium as claimed in claim 12, wherein the preset associations comprise that if the electronic device rotates a second predetermined degree up or down according to an latitudinal axis of the electronic device from an initial position and back again to the initial position, the portion of the electronic map pans a second predetermined distance up or down.
